(19) United States
(12) Patent Application Publication
(10) Pub. No.: US 2016/0363839 A1
(43) Pub. Date: Dec. 15, 2016

(54) MOUNTING SYSTEM FOR DEVICES

(71) Applicant: Paule Delaney, Scottsdale, AZ (US)

(72) Inventor: Paule Delaney, Scottsdale, AZ (US)

(21) Appl. No.: 15/179,804

(22) Filed: Jun. 10, 2016

Related U.S. Application Data
(60) Provisional application No. 62/174,470, filed on Jun. 11, 2015.

(51) Int. Cl. G03B 17/56; A45F 3/10; A45F 5/00

(52) U.S. Cl. CPC G03B 17/561; A45F 5/00; A45F 3/10

(57) ABSTRACT

A system for mounting one or more devices, such as cameras, lights, loupes, electronic displays, microphone and/or audio devices, with the devices optionally on extensions, is provided. The system may have a mounting platform and a railing system and/or a connection area. The mounting platform is preferably curved to comfortably rest around a neck and on the shoulders of the user. The mounting platform may have any shape, such as, as non-limiting examples, a collar, neck tie or necklace. The railing system or connection area provides means for connecting the one or more devices to the mounting platform. As non-limiting examples, the railing system may have a raised track or a built in track with anchor points for mounting and sliding devices along linear rails connecting the anchor points. Also as non-limiting examples, the connection area may use magnetism, suction, velcro or bolts for mounting devices to the connection area on the mounting platform.

### CROSS-REFERENCE TO RELATED APPLICATIONS

This application claims priority to co-pending U.S. Provisional Patent Application No. 62/174,470, filed Jun. 11, 2015, which is entirely incorporated herein by reference.

### FIELD OF THE INVENTION

The present invention generally relates to a mounting platform positioned upon the shoulders of a user and incorporating a mounting system used to mount and control the movements and position of items, such as one or more cameras, lights, loupes, microphones (or other audio device), electronic screens and/or extensions connected to the mounting system.

### BACKGROUND OF THE INVENTION

Cameras, lights, audio devices and extensions are known to be mounted on glasses, hats and helmets worn on the heads of users. Mounting cameras, lights, audio devices and extensions on glasses, hats and helmets allow those devices to be pointed in roughly the same direction as the user's eyes. Having the camera, lights, audio devices and extensions follow the movement of the head of the user can be desirable in some situations.

However, the user's head can often be an unstable platform for these devices. In the case of a doctor or dentist recording a procedure for example, a camera mounted to the doctor or dentist's head would record the rapid movements as the wearer's head moves back and forth. In such a case, it may be preferable to have the camera (or other device) mounted to a more stable location upon the doctor or dentist's person, where that location provides more stability and provides a different viewing angle or positioning for the device with respect to the wearer's eyes. As such, the inventor has determined that there are some situations in which it is desirable that the cameras, lights, audio devices and/or extensions not follow the movement of the user's head, but instead follow the movement of the user's shoulders.

It is thus an objective of the invention to provide a mounting system for devices such as cameras, lights, loupes, electronic screens (any type of electronic display), microphones, audio devices and/or extensions where the mounting system is securely positioned about a user's shoulders.

### SUMMARY OF THE INVENTION

The present invention provides systems for mounting one or more devices, such as cameras, lights, audio devices, loupes, electronic displays, microphones, audio equipment and/or extensions on a mounting platform. The mounting platform may include an upper surface and a lower surface and have a curvature that defines a neck opening for a user. The curvature may be shaped like a collar, C-shaped, O-shaped, tie shaped or have the shape of jewelry or other ornamental shape. The lower surface may be shaped and made from materials to comfortably rest on the shoulders of a user.

The system for mounting the one or more devices may also include a railing mounting system. The railing system may be attached or built into the upper surface of the mounting platform. The railing system may comprise a plurality of anchor points and a plurality of linear rails. The plurality of linear rails may be position between and connect two different anchor points in the plurality of anchor points. The railing system can follow the curvature of the mounting platform. Cameras, lights, loupes, electronic displays, audio devices, extensions, and other devices may then include corresponding attachment mechanisms to attach to the anchor points or the linear rails and, optionally, slide along the linear rails to be positioned along the rail or anchor point.

The system for mounting the one or more devices may, in addition or in place of the railing system, have a connection area attached to or built as part of the upper surface of the mounting platform. The connection area may use, as non-limiting examples, magnetism, suction, velcro, bolt receptacles and/or bolts, or other threaded connections to mount and support the one or more devices. In some embodiments, the one or more devices may be selectively positionable along the connection area (or raised and then reattached) to position the one or more devices as desired.

If electronic devices are connected to the mounting platform (e.g., cameras and audio devices) the electronic devices may be connected, either wired or wirelessly, to a computer, monitor or speaker. As a non-limiting example, if two cameras are used, a first camera may be wirelessly connected to a first monitor (possibly via a computer) and a second camera may be wirelessly connected to a second monitor (possibly via the computer). This may allow multiple views to be displayed for the user or for other people. Any video from any camera used may also be saved on the computer for later reference.

The above features and advantages of the present invention will be better understood from the following detailed description taken in conjunction with the accompanying drawings.

### BRIEF DESCRIPTION OF THE DRAWINGS

FIG. 1 is a mounting platform shaped as a collar or C-shaped and defining a neck opening and shaped and sized to rest on the shoulders of a user.

FIG. 2 is a mounting platform with an attached or built in railing system. The railing system comprising a plurality of knots or anchor points. A plurality of linear rails may connect the plurality of knots and anchor points allowing cameras, lights, audio devices and extensions to be slid along the linear rails from anchor point to anchor point.

FIG. 3 is a mounting platform with an attached or built in railing system and a camera and a light affixed on the end of an extension mounted at an anchor point on the mounting platform.

FIG. 4 is a mounting platform with an attached or built-in railing system and a camera and a light (low profile version, no or short extension) mounted at an anchor point on the mounting platform.

FIG. 5 is a mounting platform with a camera and light pointed in the opposite direction the user is facing.

FIG. 6 is an illustration of a mounting platform generally shaped as a collar resting on the shoulders of a user.

FIG. 7 is an illustration of a mounting platform generally shaped as a neck tie and defining a neck opening and shaped and sized to rest on the shoulders of a user.

FIG. 8 is an illustration of a mounting platform generally shaped as a tie resting on the shoulders of a user.

FIG. 9 is an illustration of a mounting platform generally shaped as a necklace and defining a neck opening and shaped and sized to rest on the shoulders of a user.

FIG. 10 is an illustration of a mounting platform generally shaped as a necklace resting on the shoulders of a user.

FIG. 11 is a blown-up cross section view of a mounting platform with a built in slot track system that allows cameras, lights, audio devices and/or extensions to be inserted at anchor points and slid along the built in track.

FIG. 12 is a T-shaped connection that may be used to connect a camera, light and/or audio device with the built in track system illustrated in FIG. 11.

FIG. 13 is a blown-up cross section view that illustrates the T-shaped connected in FIG. 12 being used with the built in slot track system in FIG. 11.

FIG. 14 is a blown-up cross section view that illustrates a railing system that is a raised track built over the mounting platform.

FIG. 15 is a C-shaped connection that may be used to connect a camera, light and/or audio device to the raised track illustrated in FIG. 14.

FIG. 16 is the C-shaped connection in FIG. 15 being used with the raised track built over the mounting platform illustrated in FIG. 14.

FIG. 17 is a blown-up cross section view that illustrates a connection area attached to the upper surface of the mounting platform.

FIG. 18 is a connection that may be mounted to the connection area attached to the upper surface of the mounting platform illustrated in FIG. 17.

FIG. 19 is the connection in FIG. 18 attached to the connection area illustrated in FIG. 17.

FIG. 20 is a mounting platform with an example method of connecting a camera, light, audio device to an anchor or mounting point attached to the mounting platform.

FIG. 21 is a mounting platform with an example method of connecting a camera, light, audio device to an anchor or mounting point in the mounting platform.

FIGS. 22-29 illustrate a camera anchored to a mounting platform that is configured to rest on the collar of a user.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

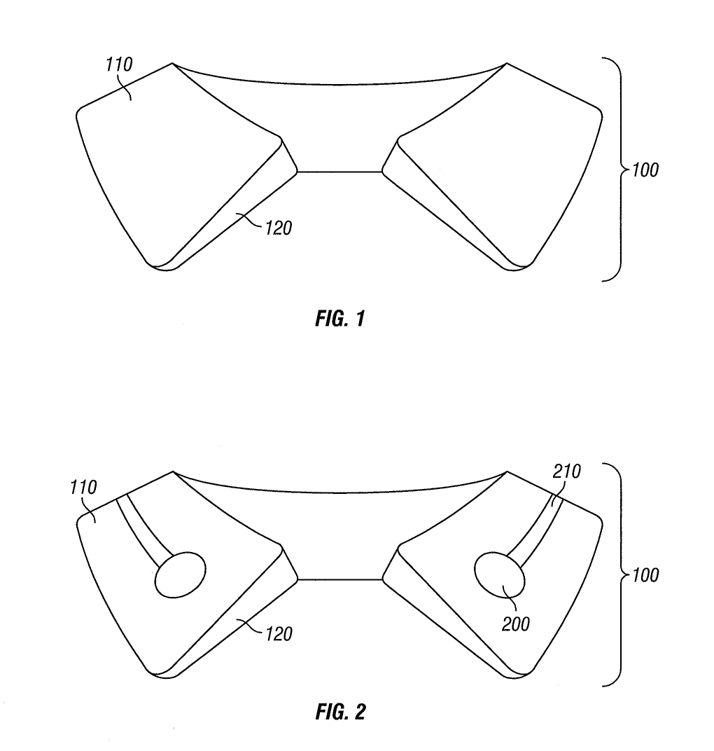

With reference to FIG. 1 a mounting platform 100 is illustrated. The mounting platform 100 may be any desired shape. In preferred embodiments, the mounting platform 100 may have a curvature that defines a neck opening for the neck of a user. The mounting platform 100 may go partially or all the way around the neck of the user and the mounting platform 100 may rest on the collar bones and/or the shoulders of the user. As non-limiting examples, the mounting platform 100 may be shaped like a collar, C-shaped, O-shaped, shaped like a tie or shaped like jewelry. In embodiments, the mounting platform 100 forms more than a semicircle, but less than a full circle.

The mounting platform 100 may be any desired width. In general the wider the mounting platform 100 the more stable the attached or built in railing system or connection area 1700 and thus the more stable the mounted devices, such as cameras 310, lights 320, loupes, electronic displays, microphone and audio devices. In preferred embodiments, the mounting platform 100 may be between 1 inch and 5 inches wide and most preferably may be between 2 inches and 4 inches wide. The mounting platform 100 may be any desired thickness. In preferred embodiments, it is between ¼ of an inch and 2 inches depending on the type of railing system or connection area 1700 used and the materials selected. A careful balance of weight, comfort for the user and stability for the attached devices may be maintained.

The mounting platform 100 may be expandable to make it easier to put the mounting platform 100 around a user's neck and/or to accommodate users with different neck sizes. The mounting surface may be relatively light-weight to make it easier to wear for extended lengths of time, while being strong enough to support cameras 310, lights 320, loupes, electronic displays, audio devices and/or extensions 300 attached to the mounting platform's upper surface 110.

The mounting platform 100 may comprise one or more layers. In a preferred embodiment, the mounting platform 100 has an upper surface 110 made of a first material and a lower surface 120 made of a second different material. The upper surface 110 preferably provides some of the strength needed for supporting devices, such as cameras 310, lights 320, loupes, electronic displays, microphone, audio devices and/or extensions 300 mounted to the mounting platform 100. The upper surface 110 may be made from any material. In preferred embodiments, and as non-limiting examples, the upper surface 110 may be flexible and be made of plastic or a lightweight metal, such as aluminum or titanium, or a composite material that is light weight and flexibility yet stiff enough to support multiple mounted devices.

Any suitable mounting system may be utilized to attach or mount the one or more devices to upper surface 110 of mounting platform 100. Although the following disclosure provides a number of specific examples of mounting system, and explains the operation of each, it should be appreciated that other mounting systems may be utilized to securely couple one or more devices, such as cameras 310, lights 320, loupes, electronic displays, microphones (or other audio devices) and/or extensions 300 to mounting platform 100. It should be appreciated that other types of devices, such as electronic screens, documents or clip-boards, dictation devices, lenses or optical filters (or other optical devices), magnifying lenses, and the like could be mounted to the present mounting platform 100. However, throughout this disclosure for simplicity of explanation, particular devices are described in the examples.

The mounting platform 100 may also have a lower surface 120. The lower surface 120 may be in contact with the user's collar bones or shoulders and thus advantageously may be soft and conform to the shape of the user's body for added comfort. In embodiments, the lower surface 120 of the mounting platform 100 is made of fabric, rubber, foam or neoprene, or combinations thereof.

With reference to FIG. 2, a mounting platform 100 with a railing system is illustrated. In this embodiment, the railing system has a plurality of anchor points 200 and a plurality of linear rails 210. Each linear rail 210 may connect two anchor points 200. Any number of anchor points 200 or linear rails 210 may be used and the anchor points 200 and linear rails 210 may be positioned at any desired location on the mounting platform 100. One or more anchor points 200 may allow the height of the camera 310 to be adjusted, such as by telescoping or stretching the anchor point, and/or allow the camera 310 to rotate to point in different directions.

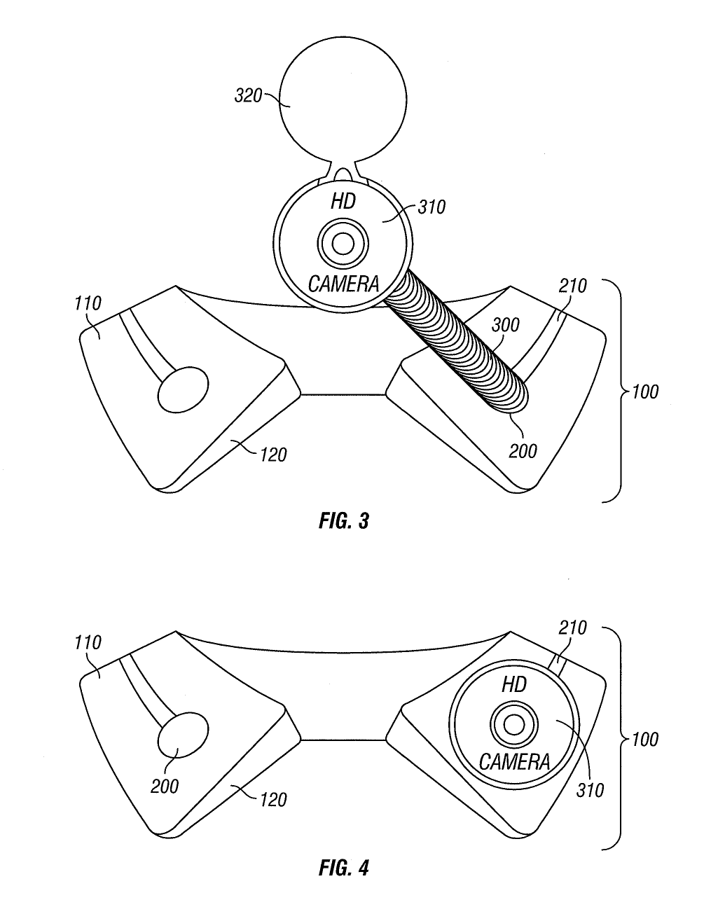

With reference to FIG. 3, a mounting platform 100 is illustrated with an attached or built in railing system. A camera 310 and a light 320 are affixed to one end of an extension 300 and the other end of the extension 300 is mounted at an anchor point on the mounting platform 100. Extension 300 is stiff enough to support both camera 310 and light 320, but can be bent or adjusted allowing a user to position camera 310 and light 320 as desired. The end of the extension 300 mounted at the anchor point may be slid along the linear rail 210 thereby adjusting the position of the camera 310 and the light 320. In another embodiment, the end of the extension 300 mounted at the anchor point may be slid along the linear rail 210 to a different anchor point thereby adjusting the position of the camera 310 and the light 320. The camera 310 and light 320 may be moved any number of times as desired along the linear rail 210 from anchor point to anchor point.

In some embodiments, anchor points 200 may be reinforced and be stronger locations for mounting and leaving cameras 310, lights 320 and audio devices. In other embodiments, anchor points 200 are merely locations for initially attaching devices such as cameras 310, lights 320, loupes, electronic displays, microphones, audio devices and/or extensions 300 to the railing system and the cameras 310, lights 320, loupes, electronic displays, microphones, audio devices and/or extensions 300 are preferably moved away from the anchor points 200 to leave the cameras 310, lights 320, loupes, electronic displays, microphones, audio devices and/or extensions 300 at some desired location on a linear rail 210.

With reference to FIG. 4, a mounting platform 100 is illustrated with an attached or built in railing system and a camera 310 and a light 320 is mounted at an anchor point on the mounting platform 100. In this embodiment, a low profile camera 310 can used that either has no extension 300 or a very short extension 300. The camera 310 may be moved along the linear rails 210 as desired.

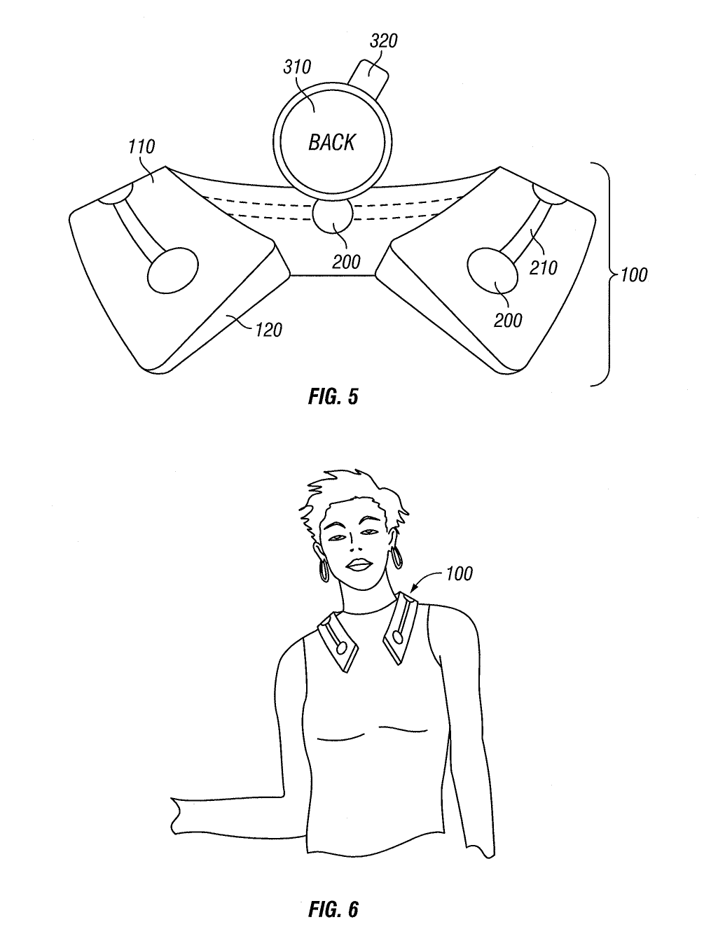

With reference to FIG. 5, a mounting platform 100 is illustrated with a camera 310 and light 320 pointed in the opposite direction the user is facing. It should be understood that while only a single camera 310 is illustrated, two or more cameras 310, two or more lights 320 and/or two or more audio devices (either using extensions 300 or not using extensions 300) may be attached to the mounting platform 100.

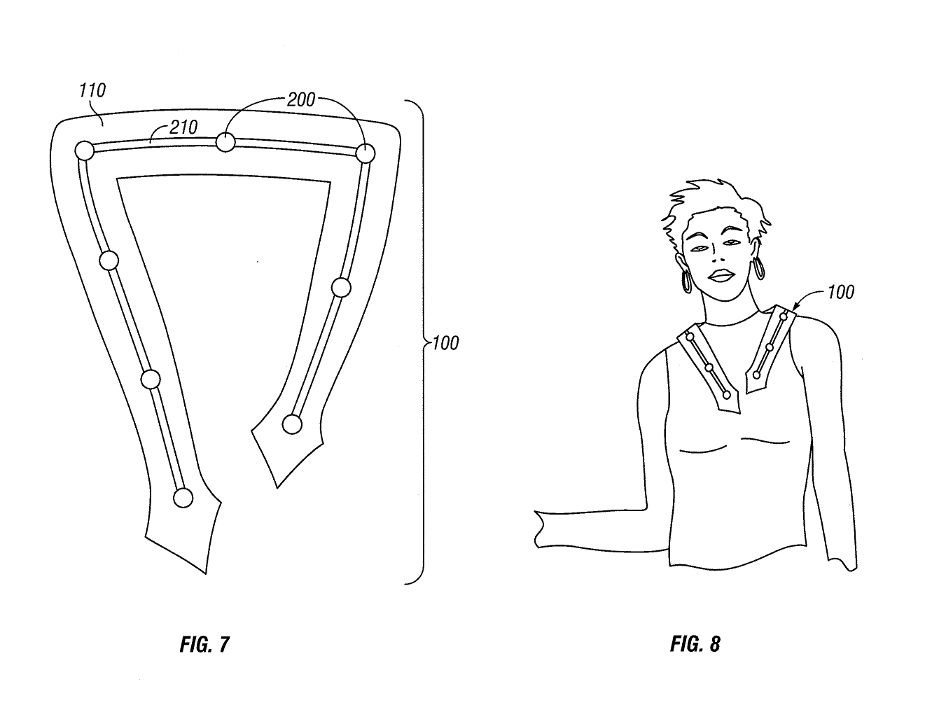

With reference to FIG. 6, a mounting platform 100 is illustrated that is generally shaped as a collar. The collar defines a neck open for the user and may rest on the shoulders of the user. This configuration allows the user to move the user's head without changing the camera's view while allowing the user to change the camera's view with shoulder movement of the user.

With reference to FIG. 7, a mounting platform 100 is illustrated that is generally shaped as a neck tie. The neck tie has a curvature that defines a neck open for the neck of the user. The mounting platform 100 is shaped and sized to rest or lay on the shoulders of the user. The upper surface 110 of the mounting platform 100 may be colored and patterns applied to give the appearance of an actual neck tie. With reference to FIG. 8, a mounting platform 100 is illustrated that is generally shaped as a tie resting on the shoulders of a user.

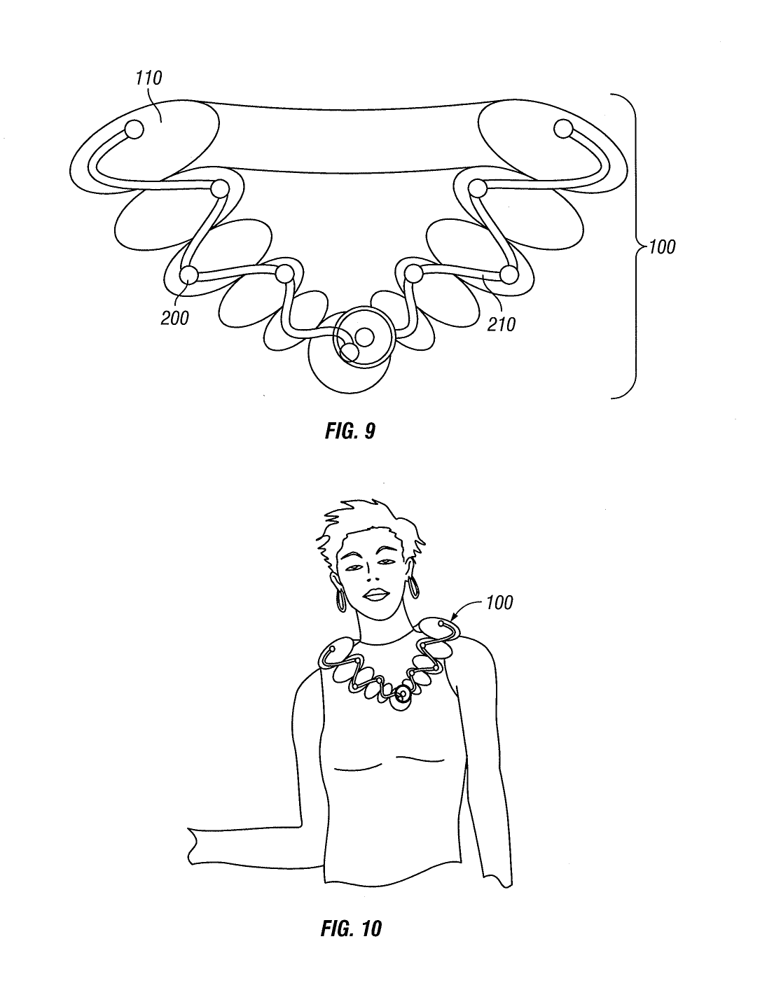

With reference to FIG. 9, a mounting platform 100 is illustrated that is generally shaped as a necklace or jewelry. The necklace or jewelry defines a neck hole for the user and may entirely encircle the neck of the user. The necklace or jewelry may be shaped and sized to rest on the shoulders of the user.

As can be appreciated from FIGS. 1, 7 and 9, the mounting platform 100 is not limited to any particular shape. Non-limiting examples of a collar (FIG. 1), neck tie (FIG. 7) and jewelry (FIG. 9) have been illustrated, but other shapes may also be used. Different shapes of the mounting platform 100 may be selected depending on the desired locations for cameras 310, lights 320, audio devices and/or extensions 300 or other devices. As an example, if camera 310 is desired near the end of a user's shoulder, the mounting platform 100 may be shaped to have anchor points 200 or attachment points near the end of the user's shoulder. In a similar manner, if a camera 310 is desired lower on a user's torso, the mounting platform 100 may be shaped to extend lower down the user's torso thereby allowing a camera 310 to be connected to the mounting platform 100 lower on the user's torso. With reference to FIG. 10, a mounting platform 100 is illustrated that is generally shaped as a necklace or jewelry resting on the shoulders of a user.

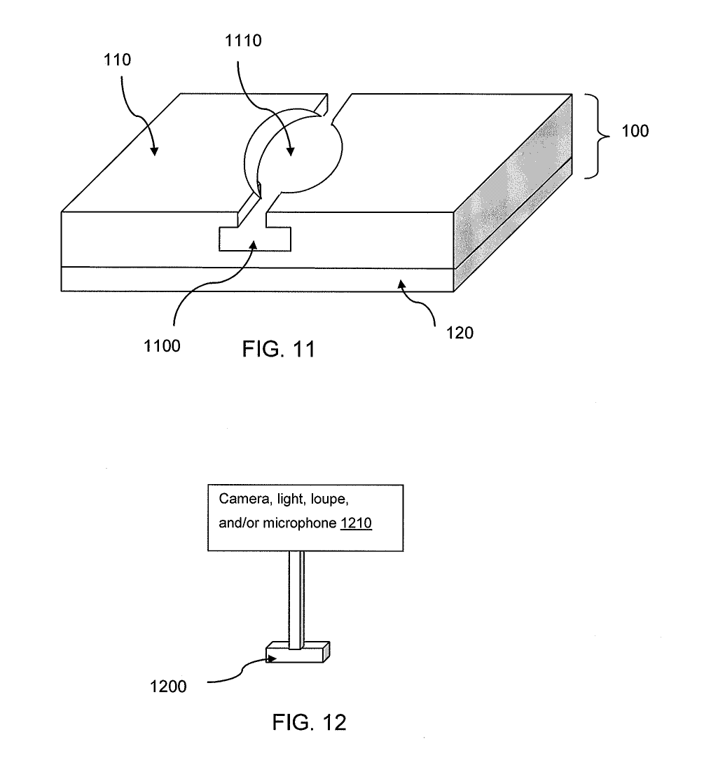

With reference to FIG. 11, a mounting platform 100 is illustrated using a blown-up cross section view of a built in slot track system. The slot track system may allow cameras 310, lights 320, loupes, electronic displays, audio devices and/or extensions 300 to be inserted at knots, anchor points 200 or track insertion points 1110 and slid along the built in track 1100. Cameras 310, lights 320, loupes, electronic displays, audio devices and/or extensions 300 may be turned or rotated without coming out of the track as long as they are not over one of the insertion points.

With reference to FIG. 12, a T-shaped connection (T-attachment 1200) is illustrated that may be used to connect a camera 310, light 320, loupe, electronic displays, and/or audio device to the built in track 1100 system illustrated in FIG. 11. The part of the T-attachment 1200 that slides along the built in track 1100 may have any shape that may be inserted into an insertion point, but remains trapped in the built in track 1100 while sliding along the built in track 1100. As non-limiting examples, the part of the T-attachment 1200 that slides along the built in track 1100 may be shaped as a cube, cuboid or cylinder. The part of the T-attachment 1200 that extends out of the built in track 1100 may be cuboid or cylindrical and may attach to a camera 310, light 320, loupe, electronic displays, audio device and/or extension 300.

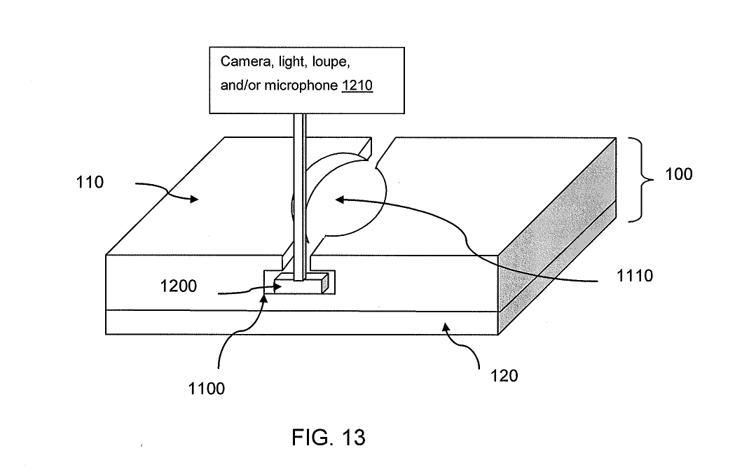

With reference to FIG. 13, the T-attachment 1200 in FIG. 12 is being used with the built in slot track system in FIG. 11. The T-attachment 1200 may have been inserted in the insertion point and slid along the built in track 1100.

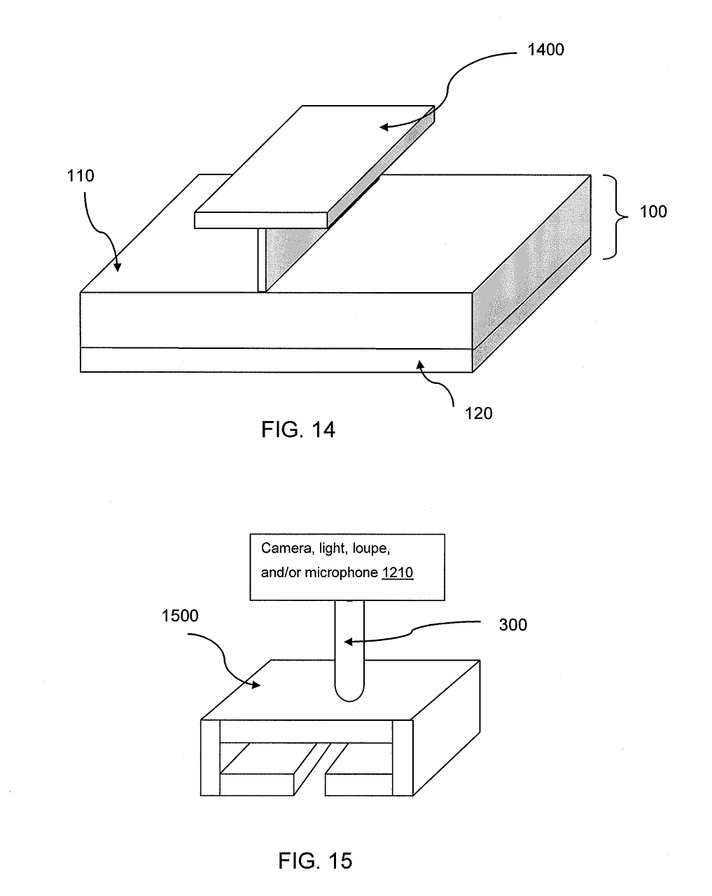

With reference to FIG. 14, a railing system is illustrated that is a raised track 1400 built over the mounting platform 100. The raised track 1400 may be made of any desired material. As non-limiting examples, the raised track 1400 may be made of a hard plastic, ceramic or metal. The raised track 1400 is preferably smooth so that the clamp 1500 in FIG. 15 may easily slide along the raised track 1400.

With reference to FIG. 15, a C-shaped connection (clamp 1500) is illustrated that may be used to connect a camera 310, light 320 and/or audio device to the raised track 1400 illustrated in FIG. 14. The clamp 1500 may be made of any desired material. As non-limiting examples, the clamp 1500 may be made of hard plastic, ceramic or metal. The clamp 1500 may be connected to or made part of a camera 310, light 320, audio device or extension 300.

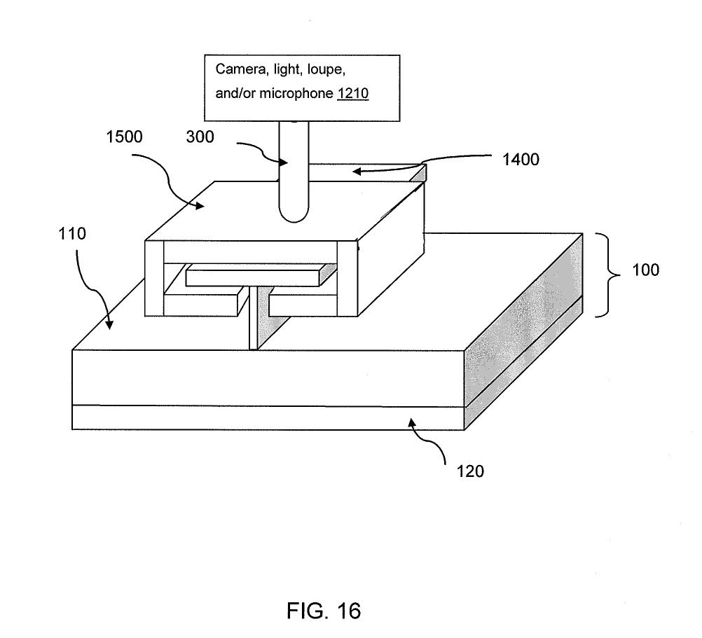

With reference to FIG. 16, the C-shaped connection in FIG. 15 (clamp 1500) is being used with the raised track 1400 built over the mounting platform 100 illustrated in FIG. 14. As can be seen, the clamp 1500 may slide along the raised track 1400 so as to position a camera 310, light 320, audio device or extension 300 to any desired location on the linear rail 210 of the raised track 1400.

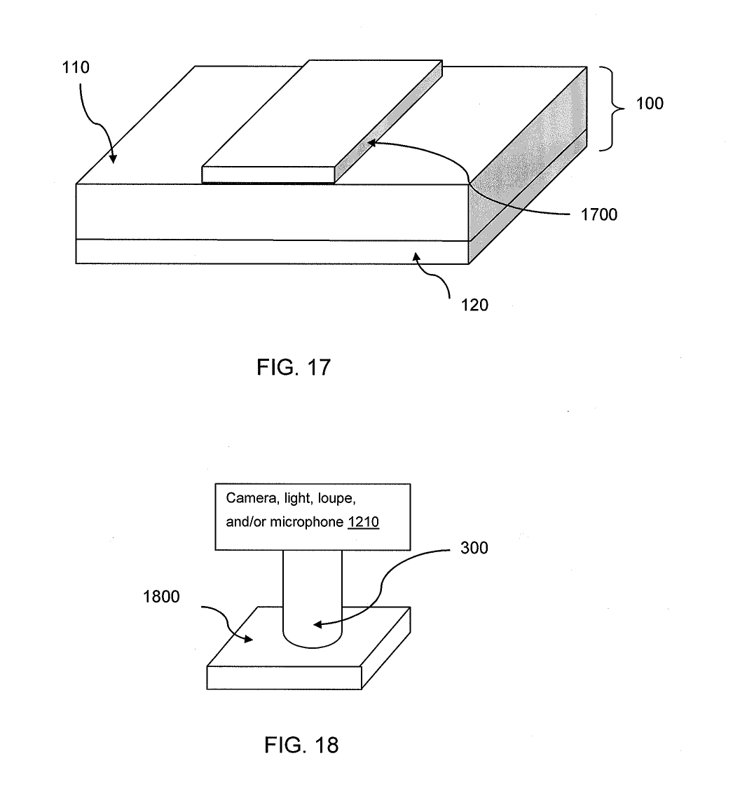

With reference to FIG. 17, a connection area 1700 is illustrated that may be attached to the upper surface 110 of the mounting platform 100. In other embodiments, the entire upper surface 110 of the mounting platform 100 may be the connection area 1700. The connection area 1700 may use any desired method of connecting a camera 310, light 320, audio device and/or extension 300 to the connection area 1700. As non-limiting examples, the connection area 1700 may use magnets (such as permanent or electromagnets), suction, velcro, receptacles 2100 for bolts 2110 or screws or bolts 2000 or screws configured to be attached to bolt 2110 or screw receptacles in cameras 310, lights 320, audio devices and/or extensions 300.

With reference to FIG. 18, a connection plate 1800 is illustrated that may be mounted to the connection area 1700 where the connection area 1700 is attached to or is the upper surface 110 of the mounting platform 100 illustrated in FIG. 17. The connection plate 1800 preferably corresponds to the type of connection area 1700 being used. Thus, if connection area 1700 is using magnetism for attraction, the connection plate 1800 must be magnetically attracted to the connection area 1700. If the connection area 1700 is using suction for attraction, the connection plate 1800 may be a suction cup or other suction method of attaching to the connection area 1700. If the connection area 1700 is using Velcro, the connection plate's lower surface 120 may be covered in Velcro so as to firmly attach to the connection area 1700. If the connection area 1700 is using receptacles 2100 for bolts 2110 the connection plate 1800 must be a matching sized and threaded bolt 2110. If the connection area 1700 is using bolts 2000, the connection plate 1800 must have a receptacle with nut threads for receiving the bolt.

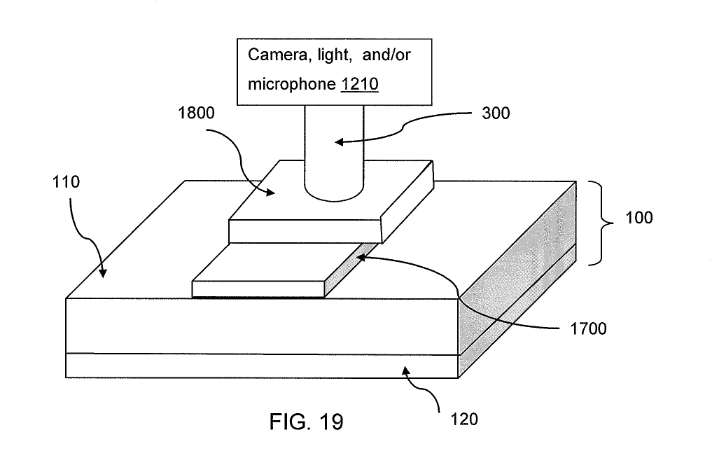

With reference to FIG. 19, the connection plate 1800 in FIG. 18 is attached to the connection area 1700 illustrated in FIG. 17 by any desired connection method.

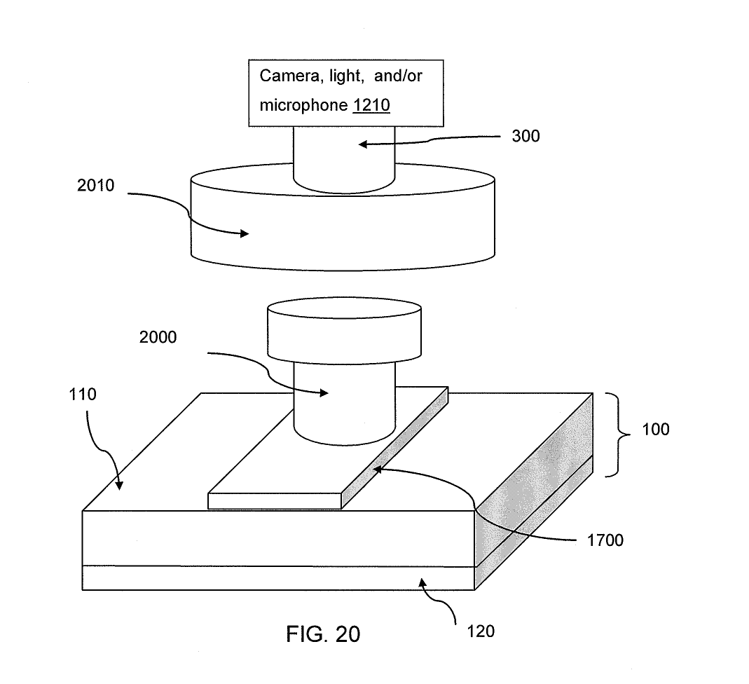

With reference to FIG. 20, a mounting platform 100 is illustrated with an example method of connecting a camera 310, light 320, or audio device to an anchor point 2000 attached to the mounting platform 100. Any desired method may be used to connect the receptacle 2010 to the anchor point 2000.

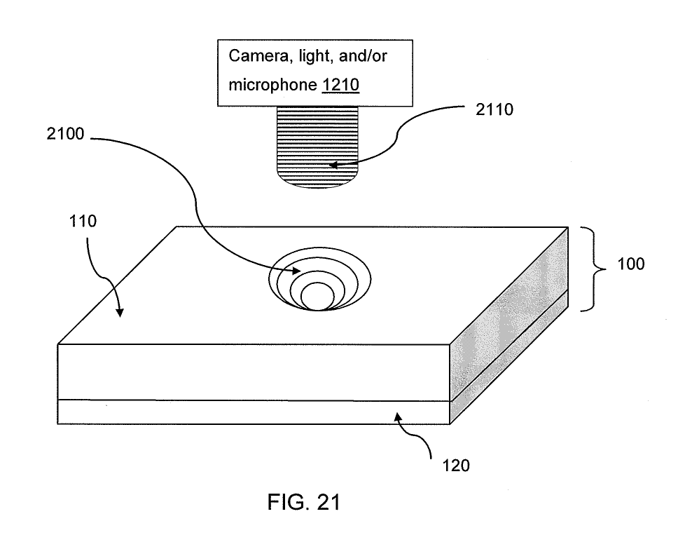

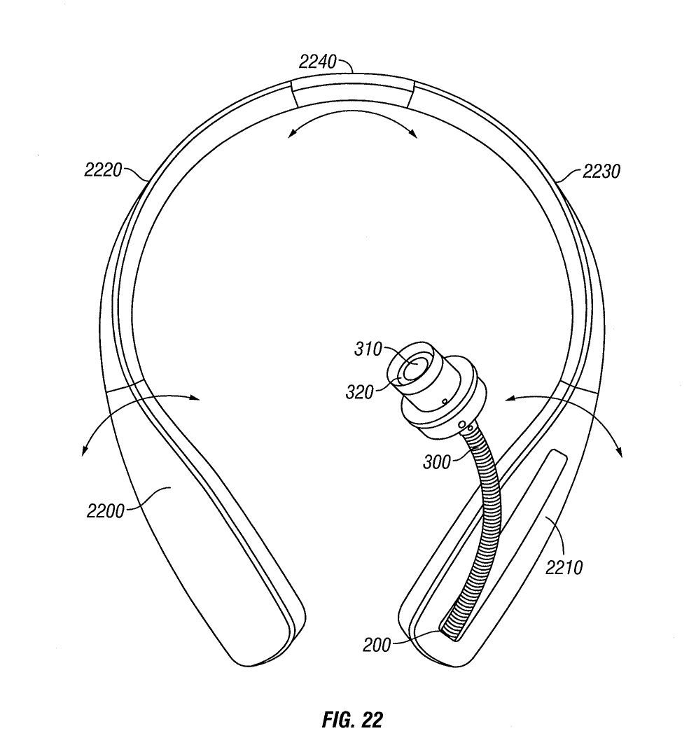

With reference to FIG. 21, a mounting platform 100 is illustrated with an example method of connecting a camera 310, light 320, loupes, electronic displays, or audio device to an anchor in the mounting platform 100. In this embodiment, the mounting platform 100 includes anchor points 200 that are receptacles for bolts or other threaded inserts. The camera 310, light 320, loupes, electronic displays, or audio device may have matching bolts that may be inserted into the anchor points 200 to firmly attach a camera 310, light 320, loupe, electronic displays, or audio device to the mounting platform 100.

In some embodiments, the anchor points 200 may be locations in the railing system for inserting connection devices into the mounting platform 100.

In another embodiment, a system for mounting a camera 310, light 320, loupe, electronic displays, audio device and/or extension 300 may include a mounting platform 100. The mounting platform 100 may include an upper surface 110 and a lower surface 120. The mounting platform 100 may have a curvature that defines a neck hole for a user. The curvature may be shaped like a collar, C-shaped, O-shaped, tie shaped or have the shape of jewelry. The mounting platform 100 may have a lower surface 120 that is shaped to rest on the shoulders of a user.

The system for mounting a device, such as camera 310, light 320, loupes, electronic displays, microphones, audio device or extension 300, may also comprise a railing system. The railing system may be attached or built into the upper surface 110 of the mounting platform 100. The railing system may comprise a plurality of anchor points 200 and a plurality of linear rails 210. The plurality of linear rails 210 may be position between and connect two different anchor points 200 in the plurality of anchor points 200. The railing system preferably follows the curvature of the mounting platform 100.

In other embodiments, the mounting platform 100 may comprise a flexible weight bearing outer surface and a compressible inner surface.

In other embodiments, the flexible weight bearing outer surface is made of a plastic and the compressible inner surface is made of neoprene, rubber or foam.

In other embodiments, the railing system is a slot track built into the mounting platform 100.

In other embodiments, the railing system is a raised track 1400 built over the mounting platform 100.

In other embodiments, each linear rail 210 in a plurality of linear rails 210 comprises an elongated rail or slot along which a connection portion of a device may be slid from a first anchor point in the plurality of anchor points 200 to a second anchor point in the plurality of anchor points 200.

In other embodiments, the mounting platform 100 is expandable to define a plurality of different sized neck holes.

In another embodiment, a system for mounting a device, such as camera, light, loupe, electronic displays, microphone and/or audio device 1210 and/or an extension 300, may include a mounting platform 100. The mounting platform 100 may comprise an upper surface 110 and a lower surface 120. The mounting platform 100 may have a curvature that defines a neck hole and the lower surface 120 of the mounting platform 100 may be configured to rest on the shoulders of a user. The system may also comprise a connection area 1700. The connection area 1700 may be attached to the upper surface 110 of the mounting platform 100. The connection area 1700 preferably follows the curvature of the mounting platform 100.

In another embodiment, the connection area 1700 comprises a material to magnetically attract a connection point of an extension 300, a connection point of a light 320 and/or a connection point of a camera 310.

In another embodiment, the connection area 1700 is smooth and configured to hold by suction a suction end of an extension 300, a suction end of a light 320 and/or a suction end of a camera 310.

In another embodiment, the connection area 1700 is covered by velcro.

In another embodiment, the connection area 1700 comprises a plurality of receptor holes with nut threading configured to receive a bolt on an end of an extension 300, a bolt on an end of a light 320 or a bolt on an end of a camera 310.

In another embodiment, the mounting platform 100 is expandable to define a plurality of different sized neck holes. The mounting platform 100 may also be grasped by the user's hands and stretched to make it easier to put around the user's neck and when released by the user's hands the mounting platform 100 may contract back to its original size.

In practice a user may place a mounting platform 100 with a railing system or a connection area 1700 around the user's neck and placed on the shoulders of the user. The mounting platform 100 may of a uniform material or be made of two or more layers. The mounting platform 100 needs to be strong enough to support cameras 310, lights 320 and/or audio devices yet be flexible enough to be comfortable laying on the shoulders of a user for extended periods of time.

In a preferred embodiment, the mounting platform 100 has a flexible upper surface 110 that can support the weight of one or more cameras 310, lights 320 an audio devices and a soft lower surface 120 (such as, as non-limiting examples, foam, rubber or neoprene) that conforms and spreads the weight across the shoulders of the user.

The user may attach one or more cameras 310, lights 320 and/or audio devices to the railing system or to the connection area 1700. Any of the mounted cameras 310, lights 320 and/or audio devices may use an extension 300 or gooseneck to allow for additional control over the location of the cameras 310, lights 320 and/or audio devices.

The one or more cameras 310, one or more lights 320 and/or one or more audio devices may be attached to the mounting platform 100 by any desired method. As non-limiting examples, the cameras 310, lights 320 and/or audio devices may be attached to the mounting platform 100 using a railing system or a connection area 1700. In preferred embodiments, the railing system or connection area 1700 follows the curvature of the mounting platform 100. The longer the railing system or connection area 1700, the more locations cameras 310, lights 320 and/or audio devices may be placed on the mounting platform 100.

The railing system may be raised above the upper surface 110 of the mounting platform 100 or the railing system may be a slot track built into the mounting system. The railing system may comprise one or more anchor points 200 and one or more linear rails 210. The linear rails 210 may extend from one anchor point to another anchor point to connect the anchor points 200 together.

In some embodiments, the anchor points 200 may be places where cameras 310, lights 320 and/or audio devices may be inserted into the railing system. The cameras 310, lights 320 and/or audio devices may stay at the anchor point or the cameras 310, lights 320 and/or audio devices may be slid along the linear rails 210 to any desired location on any desired linear rail 210. Once at a desired location, the cameras 310, lights 320 and/or audio devices may be stable and supported on the mounting platform 100 so that the cameras 310, lights 320 and/or audio devices move with the shoulders of the user and not with the head of the user.

In some embodiments, the railing system may have anchor points 200 that are supportive and allow cameras 310, lights 320 and/or audio devices to be mounted to the anchor points 200. Additional anchor points 200 provide for additional devices or locations for cameras 310, lights 320 and/or audio devices to be mounted.

In some embodiments, the connection area 1700 may be the upper surface 110 of the mounting platform 100 or the connection area 1700 may cover all or some portion of the upper surface 110 of the mounting platform 100. The connection area 1700 may use any desired method for connecting cameras 310, lights 320 and/or audio devices to the mounting platform 100. As non-limiting examples, the connection area 1700 may use magnetism, suction, velcro, bolts, or screws.

The cameras 310, lights 320, audio devices and/or extensions 300 mounted to the mounting platform 100 must have connection ends that correspond to the type of railing system or connection area 1700 being used on the mounting platform 100. As non-limiting examples, if a built in slot track as illustrated in FIG. 11 is used, the cameras 310, lights 320, audio devices and/or extensions 300 used must have something similar to the T-attachment 1200 illustrated in FIG. 12; if a raised track 1400 as illustrated in FIG. 14 is used, the cameras 310, lights 320, audio devices and/or extensions 300 used must have something similar to the clamp 1500 illustrated in FIG. 15; if a connection area 1700 uses magnetism then the cameras 310, lights 320, audio devices and/or extensions 300 must have a connection that would be magnetically attracted to the connection area 1700; if the connection area 1700 uses suction, the cameras 310, lights 320, audio devices and/or extensions 300 must have an end that may apply a suction force to the connection area 1700 such as a suction cup; if the connection area 1700 uses velcro, the cameras 310, lights 320, audio devices and/or extensions 300 must have a velcro end that will connect to the velcro connection area 1700; if an anchor point has a receptacle with threads to receive a bolt then the cameras 310, lights 320, audio devices and/or extension 300 must have an end with a matching bolt that will thread into the receptacle on the mounting platform 100; and if an anchor point has a bolt with threads then the cameras 310, lights 320, audio devices and/or extensions 300 must have a receptacle with threads to receive the bolt on the mounting platform 100. These are non-limiting examples of methods for connecting cameras 310, lights 320, audio devices and/or extensions 300 to the mounting platform 100 and any other desired method may be used.

Mounted cameras 310 and audio devices may be connected, either wired or wirelessly, to computers, monitors and/or speakers. As a non-limiting example, a camera 310 may be connected to a computer via Bluetooth or Wi-Fi (WiFi) and the computer may be connected, via a cable, to a monitor so that the monitor displays whatever is seen by a mounted camera 310. Additional cameras 310, computers and monitors may be used so that additional views may be displayed to the user or to other people.

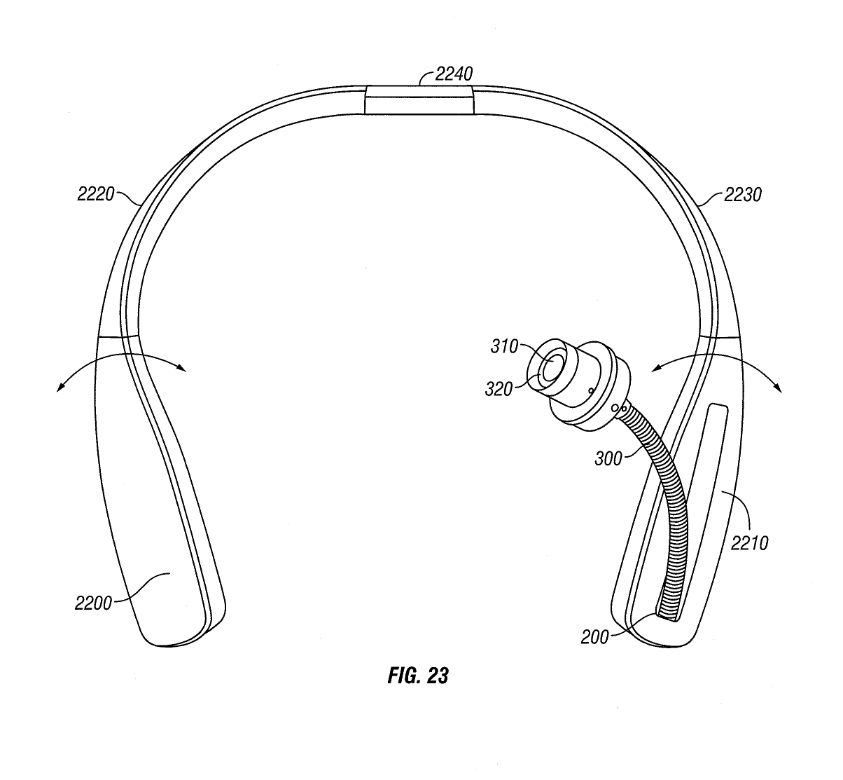

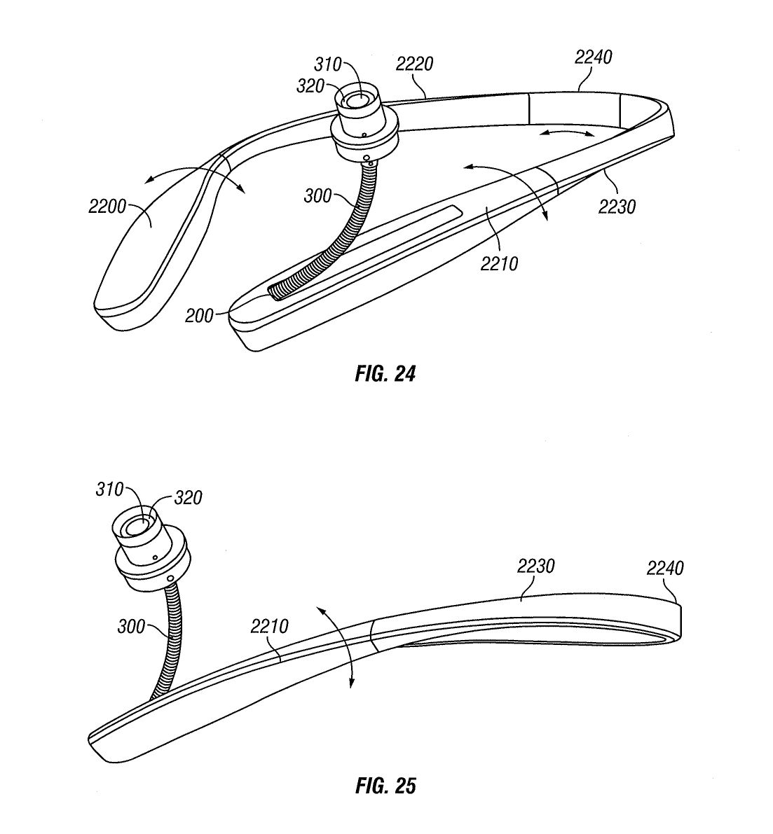

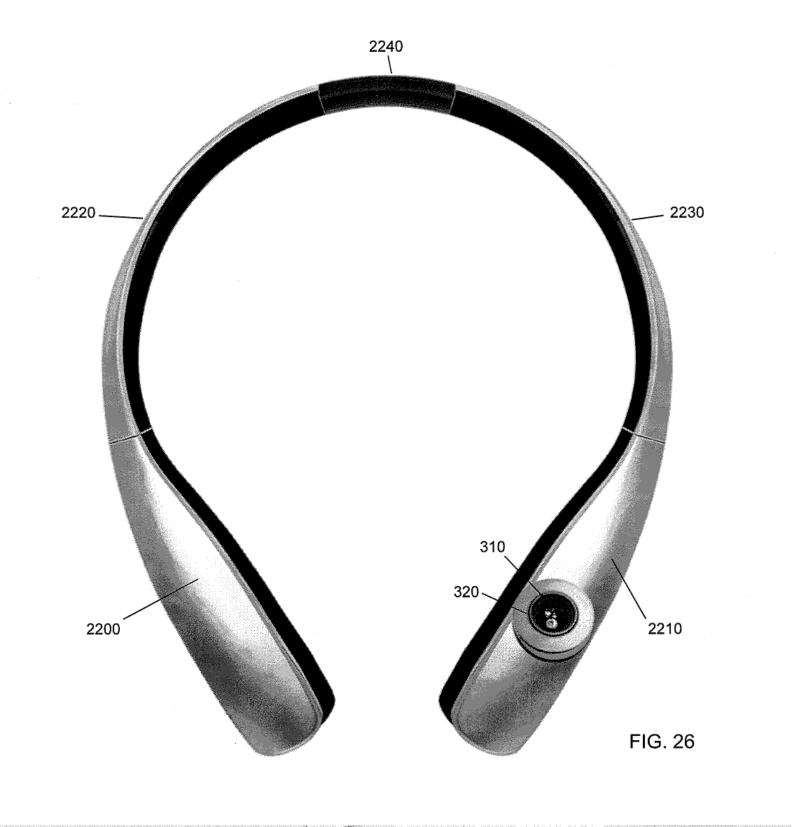

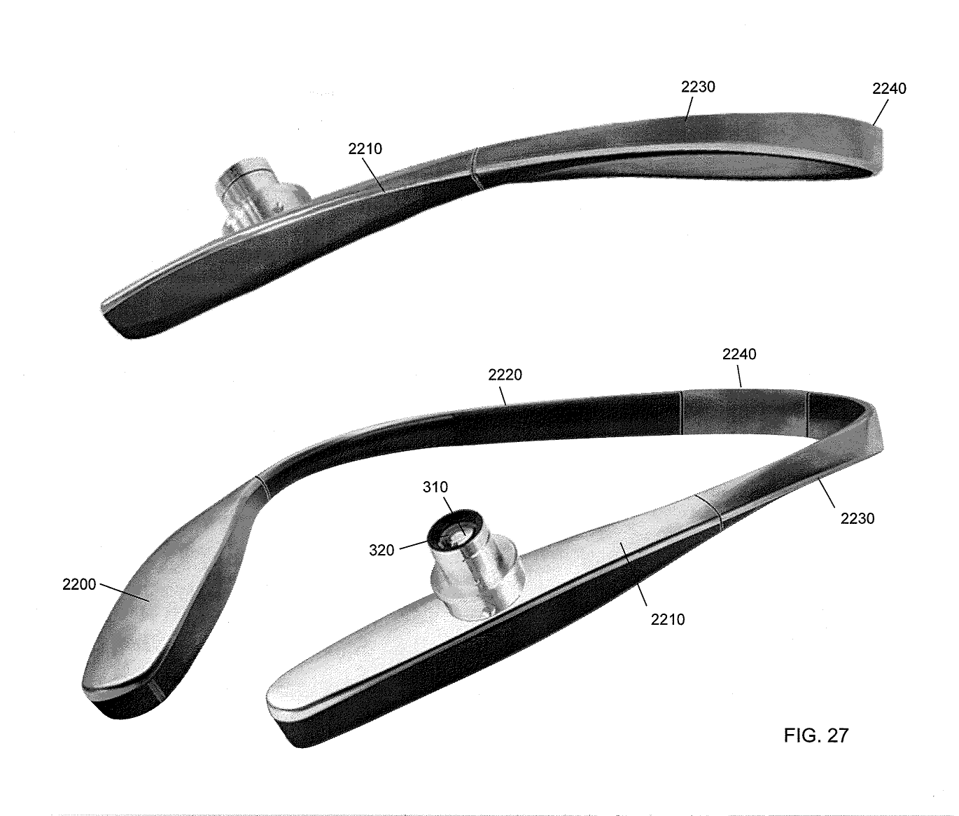

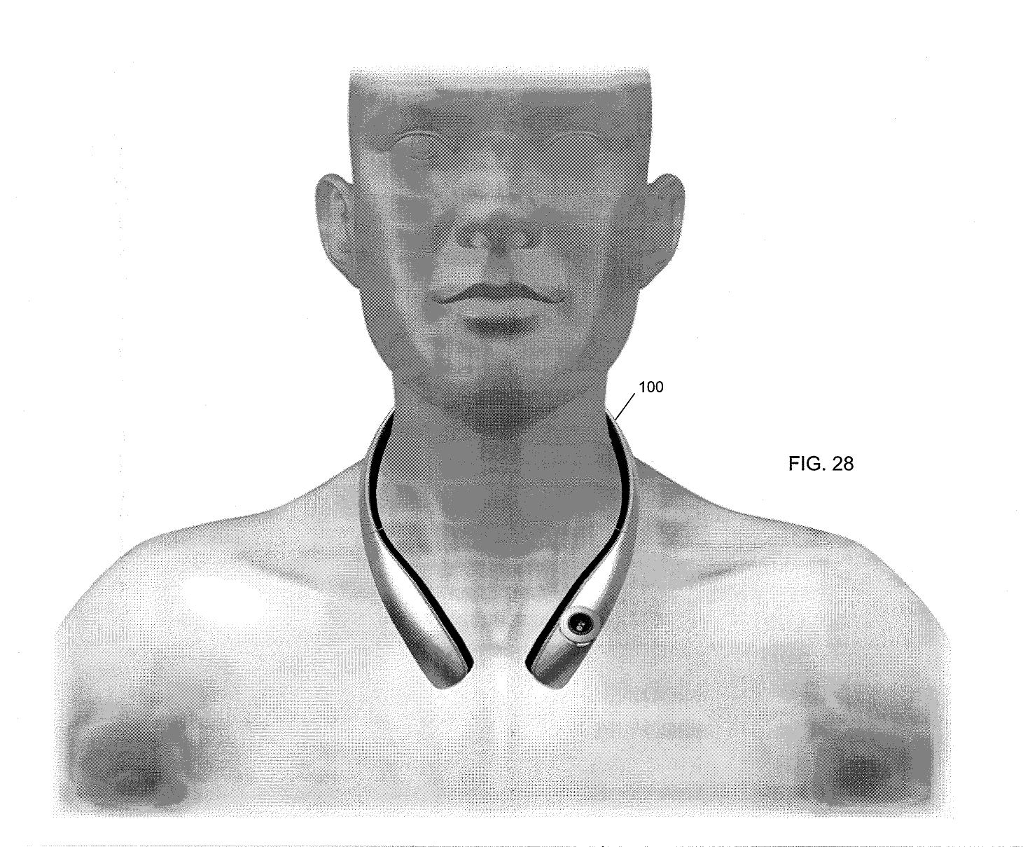

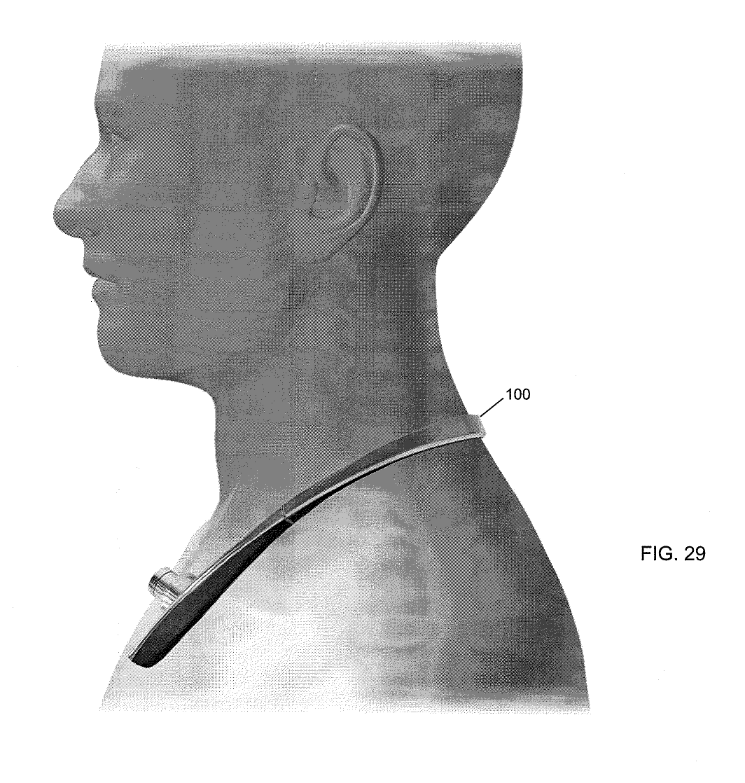

With reference to FIGS. 22-29, another embodiment is illustrated. This embodiment includes a right shoulder element 2220 configured to rest on a right shoulder of a user. The embodiment also includes a left shoulder element 2230 configured to rest on a left shoulder of the user. In preferred embodiments, the right shoulder element 2220 and the left shoulder element 2230 are made of a lightweight material, such as, as non-limiting examples, a lightweight metal (such as aluminum) or a polymer or a composite material (such as a carbon-fiber composite).

A back element 2240 may have a first end connected to the right shoulder element 2220 and a second end connected to the left shoulder element 2230. The right shoulder element 2200, back element 2240 and left shoulder element 2230 may be curved when connected and are preferably configured to comfortably surround the back and sides of the neck of the user. As a non-limiting example, the back element 2240, the right shoulder element 2220 and the left shoulder element 2230 may be configured to present a smooth vertical surface to the neck of the user. As example non-limiting dimensions, the back element 2240 is preferably between one and three inches long while the right shoulder element 2220 and the left shoulder element 2230 are preferably between three and seven inches long. As illustrated, the right shoulder element 2220 and the left shoulder element 2230 are preferably shaped as a semi cylinder or halfpipe and tapered so as to be narrower at the end that connects to the back element 2240 and wider at the end that connects to the right collar element 2200 or the left collar element 2210.

The back element 2240 may be constructed and connected to the right shoulder element 2220 and left shoulder element 2230 so as to be extendable by any desired method. As a non-limiting example, the back element 2240 may be constructed of an elastic material, so that the user may extend the back element 2240 when the user has a large neck or allow the back element 2240 to contract when the user has a small neck.

The back element 2240 may be constructed and connected to the right shoulder element 2220 and the left shoulder element 2230 so as to be easily replaceable. In this manner the back element 2240 may be replaced with a shorter back element 2240 if the user has a smaller neck and replaced with a longer back element 2240 if the user has a larger neck.

A right collar element 2200 may be connected to the right shoulder element 2220 and a left collar element 2210 may be connected to the left shoulder element 2230. The right collar element 2200 and the left collar element 2210 may be configured to present a smooth surface to a collar or a chest of the user. The right collar element 2200 may be rotatable with respect to the right shoulder element 2220 and the left collar element 2210 may be rotatable with respect to the left shoulder element 2230. Allowing the right collar element 2200 and the left collar element 2210 to rotate permits the user to adjust their position, and thus their bottom surfaces, against the collar and/or chest of the user for improved fit and comfort.

A first end of an extension 300 or a gooseneck may be connected to an anchor point 200 on either the right collar element 2200 or the left collar element 2210. A camera 310 and optionally a light 320 may be mounted on a second end of the extension 300. In preferred embodiments, the extension 300 is flexible enough to allow the user to easily hand adjust, i.e., using only the hands of the user and without using any tools, where the camera 310 (and optionally the light 320) is pointing, while at the same time the extension 300 is stiff enough to hold the camera 310 (and optionally the light 320) in position after the user has finished pointing the camera 310 in the desired direction.

Electronics for powering, controlling and transmitting a signal from the camera 310 are preferably stored in either the right collar element 2200 or the left collar element 2210 or both. In preferred embodiments, the signal from the camera 310 is wirelessly transmitted to a receiver for storage and/or display on a monitor in real-time. As non-limiting examples, the signal may be transmitted to the receiver via a radio frequency (RF) signal or using Bluetooth technology.

Other embodiments and uses of the above inventions will be apparent to those having ordinary skill in the art upon consideration of the specification and practice of the invention disclosed herein. It should be understood that features listed and described in one embodiment may be used in other embodiments unless specifically stated otherwise. The specification and examples given should be considered exemplary only, and it is contemplated that the appended claims will cover any other such embodiments or modifications as fall within the true scope of the invention.

The invention claimed is:

1. A system, comprising:
a) a mounting platform comprising an upper surface and a lower surface, the mounting platform having a curvature that defines a neck hole and the lower surface of the mounting platform is shaped to rest on the shoulders of a user; and
b) a railing system attached or built into the upper surface of the mounting platform, the railing system comprising a plurality of anchor points and a plurality of linear rails connecting the plurality of anchor points, wherein the railing system follows the curvature of the mounting platform.

2. The system of claim 1, wherein the mounting platform comprises a flexible weight bearing outer surface and a compressible inner surface.

3. The system of claim 2, wherein the flexible weight bearing outer surface comprises plastic and the compressible inner surface comprises neoprene.

4. The system of claim 1 wherein the railing system is a slot track built into the mounting platform.

5. The system of claim 1, wherein the railing system is a raised track built over the mounting platform.

6. The system of claim 1, wherein each linear rail in the plurality of linear rails comprises an elongated rail or slot along which a device may be slid from a first anchor point in the plurality of anchor points to a second anchor point in the plurality of anchor points.

7. The system of claim 1, wherein the mounting platform is expandable to define a plurality of different sized neck holes.

8. A system, comprising:
a) a mounting platform comprising an upper surface and a lower surface, the mounting platform having a curvature that defines a neck hole and the lower surface of the mounting platform is configured to rest on the shoulders of a user; and
b) a connection area attached to the upper surface of the mounting platform, wherein the connection area follows the curvature of the mounting platform.

9. The system of claim 8, wherein the connection area comprises a material to magnetically attract a connection point of an extension, a connection point of a light, a connection point of a camera, a connection point of an electronic screen and/or a connection point of a loupe.

10. The system of claim 8, wherein the connection area is smooth and configured to hold by suction a suction end of an extension, a suction end of a light, a suction end of a camera, a suction end of an electronic screen and/or a suction end of a loupe.

11. The system of claim 8, wherein the connection area is covered by velcro.

12. The system of claim 8, wherein the connection area comprises a plurality of receptor holes with nut threading configured to receive a bolt end of an extension, a bolt end of a light, a bolt end of a camera, a bolt end of an electronic screen and/or a bolt end of a loupe.

13. The system of claim 8, wherein the mounting platform is expandable to define a plurality of different sized neck holes.

14. A system, comprising:
a right shoulder element configured to rest on a right shoulder of a user;
a left shoulder element configured to rest on a left shoulder of the user;
a back element comprising a first end connected to the right shoulder element and a second end connected to the left shoulder element;
a right collar element connected to the right shoulder element;
a left collar element connected to the left shoulder element;
an extension, wherein a first end of the extension is connected to an anchor point on either the right collar element or the left collar element; and
a camera mounted on a second end of the extension, wherein the extension is flexible enough to allow the user to hand adjust where the camera is pointing and the extension is stiff enough to hold the camera in position after the user has finished pointing the camera in the desired direction.

15. The system of claim 14, wherein the back element, the right shoulder element and the left shoulder element are configured to present a smooth vertical surface to a neck of the user and the right collar element and the left collar element are configured to present a smooth surface to a collar or a chest of the user.

16. The system of claim 14, wherein the back element is configured to be replaceable with a second back element of the same, shorter and longer length.

17. The system of claim 14, wherein the back element is configured to extend or contract in length by more than an inch without damaging the back element.

18. The system of claim 14, wherein the right collar element is rotatable with respect to the right shoulder element.

19. The system of claim 14, wherein the left collar element is rotatable with respect to the left shoulder element.

20. The system of claim 14, wherein the right collar element is rotatable with respect to the right shoulder element and the left collar element is rotatable with respect to the left shoulder element.
